(19) United States
(12) Patent Application Publication
(10) Pub. No.: US 2006/0091735 A1
(43) Pub. Date: May 4, 2006

(54) Linear compressor

(75) Inventors: Gye Young Song, Seoul (KR); Je Nam Kang, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/191,924

(22) Filed: Jul. 29, 2005

(30) Foreign Application Priority Data
Nov. 2, 2004 (KR) 2004-88258

(51) Int. Cl. H02K 41/00; H02K 35/00; F04B 17/04

(52) U.S. Cl. 310/12; 310/15; 417/417

(57) ABSTRACT

Disclosed herein is linear compressor. The linear compressor comprises a cylinder, a piston disposed to linearly reciprocate into the cylinder, and a linear motor provided to linearly reciprocate the piston. The linear motor includes an outer core, a bobbin mounted in the outer core, a coil wound on the bobbin, an inner core spaced apart from the outer core to define a gap therebetween, the inner core being mounted to linearly reciprocate simultaneously with the piston, a magnet holder mounted on the inner core, and a magnet mounted in the magnet holder. The linear compressor has a simplified structure, resulting in a reduced number of parts and low manufacturing costs.

### BACKGROUND OF THE INVENTION

1. Field of the Invention

The present invention relates to a linear compressor to compress refrigerant gas, etc., and, more particularly, to a linear compressor in which an inner core is mounted to reciprocate simultaneously with a piston, and a magnet holder, having a magnet mounted therein, is mounted on the inner core.

2. Description of the Related Art

Generally, a linear compressor is configured to suction fluid, such as refrigerant gas (hereinafter, referred to as “fluid”), into a cylinder and compress the fluid by linearly reciprocating a piston inside the cylinder using a linear driving force of a linear motor to thereby discharge the fluid in a compressed state.

FIG. 1 is a sectional view illustrating the interior configuration of a conventional linear compressor.

As shown in FIG. 1, the conventional linear compressor includes a hermetic shell 2 having an inlet port 1 for the introduction of fluid from the outside, a linear compression unit 10 mounted in the hermetic shell 2 to compress the fluid, and a loop pipe 48 used to discharge the compressed fluid from the linear compression unit 10 to the outside of the hermetic shell 2.

The linear compression unit 10 includes a cylinder block 14 centrally provided with a cylinder 12, a back cover 22 having a suction pipe 20, a piston 30 disposed to linearly reciprocate into the cylinder 12, and a linear motor 40 adapted to generate a driving force for linearly reciprocating the piston 30 inside the cylinder 12.

A discharge valve assembly 16 is mounted at a front side of the cylinder 12 to define a compression chamber C between the piston 30 and the discharge valve assembly 16. If fluid inside the compression chamber C is compressed beyond a predetermined pressure, the discharge valve assembly 16 serves to discharge the compressed fluid into the loop pipe 48.

The cylinder block 14 is supported in the hermetic shell 2 in a shock-absorbing manner by means of a first damper 18.

The back cover 22 is supported in the hermetic shell 2 in a shock-absorbing manner by means of a second damper 24.

The piston 30 is formed with a flange 31 for the connection of the linear motor 40. A first spring 32 is interposed between the flange 31 and the cylinder block 14 and a second spring 33 is interposed between the flange 31 and the back cover 22 to elastically support them to elastically support the cylinder block 14 and the back cover 22.

The piston 30 internally defines a fluid suction channel 34.

A suction valve 35 is mounted at a front end surface of the piston 30 to open or close the suction channel 34.

The linear motor 40 is generally comprised of a stator S and a mover M.

The stator S includes an outer core 41 coupled between the cylinder block 14 and the back cover 22, an inner core 42 spaced apart from the outer core 41 to define a gap therebetween, a bobbin 43 mounted in the outer core 41, and a coil 44 wound around the bobbin 43.

The inner core 42 is fastened to the cylinder block 14 by means of bolts, etc., to be fixedly mounted outside the cylinder 12.

The mover M includes a magnet 46 mounted between the outer core 41 and the inner core 42 to define gaps with both the outer core 41 and the inner core 42, a cylindrical carbon frame 47 configured to support the magnet 46 seated thereon, a top plate 48 coupled to both the carbon frame 47 and the flange 31 of the piston 30, and a carbon winding 49 wound on an outer circumference of the magnet 46 seated on the carbon frame 47.

The carbon frame 47 has a magnet seating groove formed at an outer circumference thereof.

The top plate 48 is divided into a cylindrical portion 48a configured to be coupled with an end of the carbon frame 47, and a disk portion 48b extending perpendicular to the cylindrical portion 48a to come into close contact with the flange 31 of the piston 30.

The disk portion 48b is fastened to the flange 31 of the piston 30 by means of bolts 48c.

To achieve the mover M configured as stated above, first, the magnet 46, carbon frame 47, and top plate 48 are separately prepared by molding, and an adhesive is applied to an end of the carbon frame 47. After that, the end of the carbon frame 47 is pushed to the cylindrical portion 48a of the top plate 48 to be securely attached thereto. In succession, the magnet 46 is attached to the groove of the carbon frame 47 by means of an adhesive, etc. Finally, the carbon winding 49 is wound on the magnet 46.

Composing the mover M of the linear motor 40 with the magnet 46, carbon frame 47, top plate 48, and carbon winding 49, however, excessively increases the number of parts, and complicates the assembling process thereof. Thus, the conventional linear compressor suffers from a difficulty in tolerance control.

Also, the conventional linear compressor has a problem in that an attachment region between the carbon frame 47 and the top plate 48 is easily deformed. This worsens a difficulty in accurate tolerance control of the compressor.

### SUMMARY OF THE INVENTION

Therefore, the present invention has been made in view of the above problems, and it is an object of the present invention to provide a linear compressor showing a simplified structure and assembling process.

It is another object of the present invention to provide a linear compressor showing an easy tolerance control of a magnet.

In accordance with a first aspect of the present invention, the above and other objects can be accomplished by the provision of a linear compressor comprising: a cylinder; a piston disposed to linearly reciprocate into the cylinder; and a linear motor provided to linearly reciprocate the piston, wherein the linear motor includes: an outer core; a bobbin mounted in the outer core; a coil wound on the bobbin; an inner core spaced apart from the outer core to define a gap therebetween, the inner core being mounted to linearly reciprocate simultaneously with the piston; a magnet holder mounted on the inner core; and a magnet mounted in the magnet holder.

Preferably, the inner core may include a first inner core, and a second inner core coupled to a front side of the first inner core.

Preferably, one of the first and second inner cores may be provided with a protrusion, and the other one of the first and second inner cores may be provided with a recess for the insertion of the protrusion.

Preferably, the first inner core may be formed with a rear holding protrusion so that a rear end of the magnet holder is caught by the rear holding protrusion, and the second inner core may be formed with a front holding protrusion so that a front end of the magnet holder is caught by the front holding protrusion, whereby the magnet holder is mounted on the inner core as it is caught by the front and rear holding protrusions.

Preferably, the magnet holder may be made of poly-ether-ether-ketone (PEEK) or polyoxymethylene (POM).

Preferably, the magnet holder may have a cylindrical portion configured to come into close contact with an outer circumference of the inner core, and front and rear flanges radially protruded from front and rear ends of the cylindrical portion.

Preferably, the magnet may be attached to the magnet holder by means of an adhesive.

Preferably, a carbon winding may be wound on an outer circumference of the magnet mounted in the magnet holder.

Preferably, the linear motor may further include an inner core holder mounted to the piston, the inner core being mounted on the inner core holder.

Preferably, the inner core holder may include a first inner core holder inserted into the inner core so that a rear end of the inner core is caught by the first inner core holder, the first inner core holder being fastened to the piston, and a second inner core holder inserted into the inner core so that a front end of the inner core is caught by the second inner core holder, the second inner core holder being coupled with the first inner core holder inside the inner core.

According to the linear compressor of the present invention configured as stated above, since the inner core is mounted to linearly reciprocate simultaneously with the piston, and the magnet holder, having the magnet mounted therein, is mounted on the inner core, the structure of the compressor can be simplified, resulting in a reduced number of parts and low manufacturing costs.

Further, according to the present invention, the inner core includes the first inner core having the rear holding protrusion and the second inner core coupled to a front side of the first inner core and having a front holding protrusion, so that the magnet holder can be stably mounted on the inner core as front and rear ends thereof are caught by the front and rear holding protrusions of the first and second inner cores. This eliminates the need of separate adhesive for attaching the magnet holder to the inner core, and can prevent deformation of coupling regions of the inner core and the magnet holder, enabling easy tolerance control of the magnet.

Furthermore, as a result of forming the protrusion at one of the first and second inner cores and the recess at the other one of the first and second inner cores, the first and second inner cores can be easily coupled to each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating the interior configuration of a conventional linear compressor;

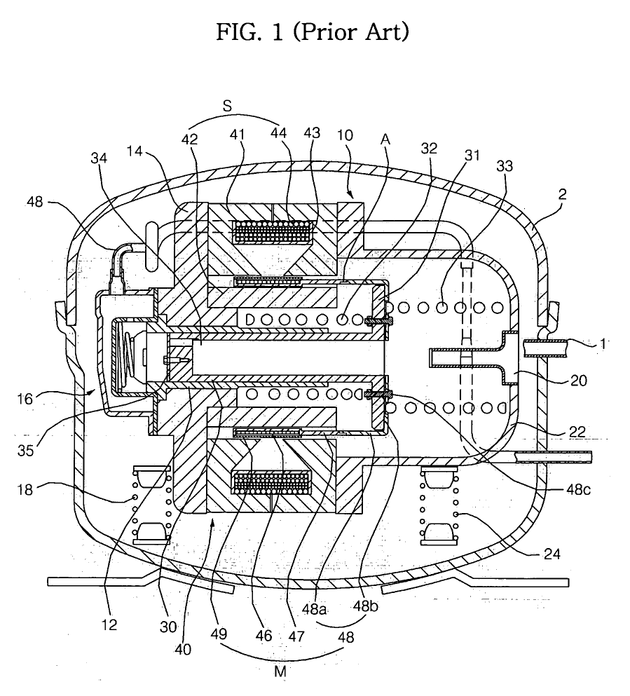

FIG. 2 is a sectional view illustrating the interior configuration of a linear compressor according to a first embodiment of the present invention;

FIG. 3 is an enlarged sectional view of the circle A shown in FIG. 2;

FIG. 4 is an exploded sectional view of a mover shown in FIG. 2;

FIG. 5 is a sectional view illustrating the interior configuration of a linear compressor according to a second embodiment of the present invention;

FIG. 6 is an enlarged sectional view of the circle B shown in FIG. 5;

FIG. 7 is a sectional view illustrating the interior configuration of a linear compressor according to a third embodiment of the present invention; and

FIG. 8 is an enlarged sectional view of the circle D shown in FIG. 7.

### DESCRIPTION OF THE PREFERRED EMBODIMENTS

Now, preferred embodiments of the present invention for achieving the above described objects will be described with reference to the accompanying drawings. In the following description, wherever possible, the same reference numerals will be used throughout the drawings to refer to the same or like parts, and thus, a detailed explanation thereof will be omitted.

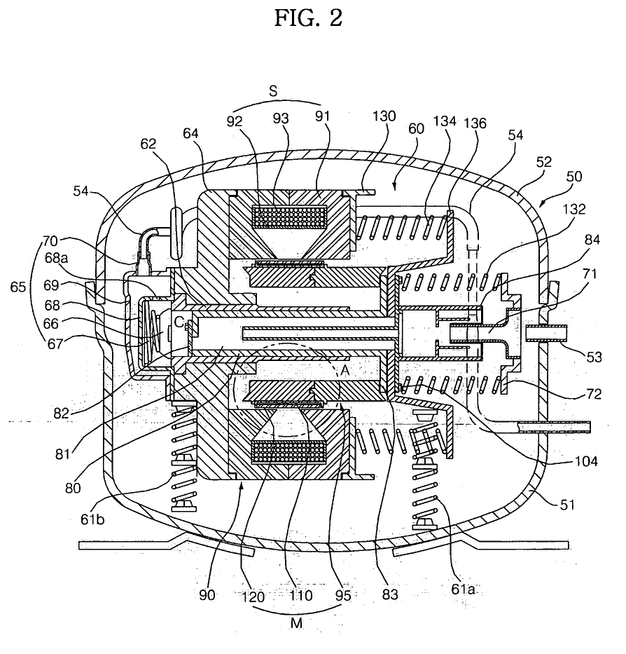

FIG. 2 is a sectional view illustrating the interior configuration of a linear compressor according to a first embodiment of the present invention.

As shown in FIG. 2, the linear compressor according to the present embodiment includes a hermetic shell 50, and a linear compression unit 60 mounted in the hermetic shell 50.

The hermetic shell 50 includes a lower shell 51, and an upper shell 52 configured to cover an upper side of the lower shell 51. In a coupled state thereof, both the lower and upper shells 51 and 52 define a hermetic space therein.

A suction pipe 53 is penetrated through the hermetic shell 50 to introduce fluid, such as refrigerant gas (hereinafter referred to as “fluid”), into the hermetic shell 50. A loop pipe 54 is also penetrated through the hermetic shell 50 to guide the compressed fluid from the linear compression unit 60 to the outside of the hermetic shell 50.

A rear portion of the linear compression unit 60 is supported by a first damper 61a that is mounted in the hermetic shell 50, and a front portion of the linear compression unit 60 is supported by a second damper 61b that is mounted in the hermetic shell 50. Thereby, the linear compression unit 60 is supported in the hermetic casing 50 in a shock-absorbing manner.

The linear compression unit 60 includes a cylinder block 64 centrally provided with a cylinder 62, a back cover 72 having a suction pipe 71, a piston 80 disposed to linearly reciprocate into the cylinder 62, and a linear motor 90 adapted to generate a driving force for linearly reciprocating the piston 80 inside the cylinder 62.

The cylinder 62 is positioned at the center of the cylinder block 64.

A discharge valve assembly 65 is mounted at a front side of the cylinder 62 to define a compression chamber C between the piston 80 and the discharge valve assembly 65. If fluid inside the compression chamber C is compressed beyond a predetermined pressure, the discharge valve assembly 65 serves to discharge the compressed fluid into the loop pipe 54.

The discharge valve assembly 65 includes a discharge valve 66 to open or close a front end of the cylinder 62, an inner discharge cover 68 having a fluid discharge hole 68a formed at one side thereof, an elastic spring 67 coupled to the inner discharge cover 68 to elastically support the discharge valve 66, an outer discharge cover 69 located at an outer side of the inner discharge cover 68 to define a fluid channel therebetween, and a fluid discharge pipe 70 mounted to the outer discharge cover 69 to be connected to the loop pipe 54.

The back cover 72 is fastened to an outer core cover 130, which will be described hereinafter, by means of fastening means, such as bolts.

The piston 80 has a fluid suction channel 81 longitudinally defined therein.

A suction valve 82 is mounted at a front end surface of the piston 80 to open or close the suction channel 81.

Here, the suction valve 82 is an elastic member affixed to the front end surface of the piston 80 by means of bolts. The suction valve 82 is designed to open or close the suction channel 81 by making use of a pressure difference between the compression chamber C and the suction channel 81.

At a rear end of the piston 80 is formed a flange 83 for the connection of the linear motor 90.

A muffler 84 is mounted at a rear side of the piston 80 so that fluid, introduced via the suction pipe 71 of the back cover 72, passes through the muffler 84.

The linear motor 90 is generally comprised of a stator S and a mover M.

The stator S includes an outer core 91, a bobbin 92 mounted in the outer core 91, and a coil 93 wound on the bobbin 92.

The outer core 91 is made of laminated iron cores, and is coupled to a side of the cylinder block 64 by means of fastening means, such as bolts.

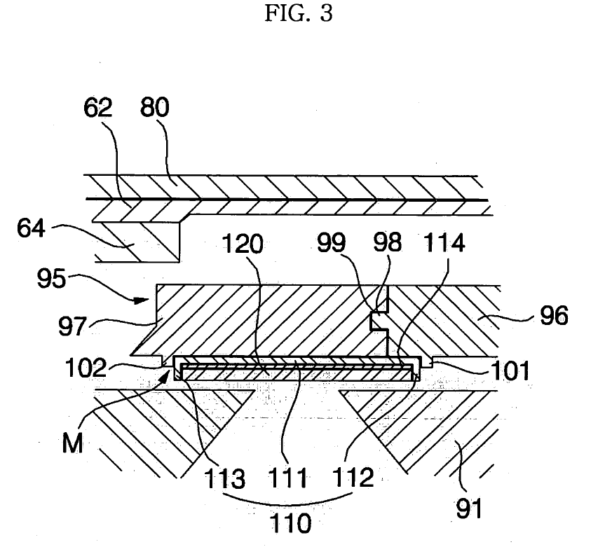

FIG. 3 is an enlarged sectional view of the circle A shown in FIG. 2.

As shown in FIGS. 2 and 3, the mover M includes an inner core 95 spaced apart from the outer core 91 to define a gap therebetween and adapted to linearly reciprocate simultaneously with the piston 80, a magnet holder 110 mounted on the inner core 95, and a magnet 120 mounted in the magnet holder 110.

The inner core 95 is divided into a first inner core 96, and a second inner core 97 coupled to a front side of the first inner core 96.

One of the first and second inner cores 96 and 97 is provided with a protrusion 98, and the other one of the first and second inner cores 96 and 97 is provided with a recess 99. As the protrusion 98 is inserted into the recess 99, the first and second inner cores 96 and 97 are coupled to each other. For convenience of explanation, the following description is specifically limited to formation of the protrusion 98 at the first inner core 96 and the recess 99 at the second inner core 97.

The protrusion 98 is configured to be press fitted into the recess 99.

The first inner core 96 is formed with a rear holding protrusion 101 so that a rear end of the magnet holder 110 is caught by the rear holding protrusion 101. The second inner core 97 is formed with a front holding protrusion 102 so that a front end of the magnet holder 110 is caught by the front holding protrusion 102.

As shown in FIG. 2, the first inner core 96 is fastened to the flange 83 of the piston 80 by means of bolts, or is attached to the flange 83 using an adhesive.

The magnet holder 110 is mounted to be caught by both the front and rear holding protrusions 101 and 102.

The magnet holder 110 is made of poly-ether-ether-ketone (PEEK) or polyoxymethylene (POM).

The magnet holder 110 has a cylindrical portion 111 configured to come into close contact with an outer circumference of the inner core 95, a rear flange 112 radially protruded from a rear end of the cylindrical portion 111, and a front flange 113 radially protruded from a front end of the cylindrical portion 111.

Here, a distance between the front and rear flanges 113 and 112 is slightly longer than or equal to the length of the magnet 120. Also, a protruding width of the front and rear flanges 113 and 112 is slightly longer than or equal to the thickness of the magnet 120.

When the length of the magnet 120 is equal to the distance between the front and rear flanges 113 and 112, the magnet 120 is able to be press fitted between the front and rear flanges 113 and 112. Otherwise, when the length of the magnet 120 is slightly shorter than the distance between the front and rear flanges 113 and 112, the magnet 120 is first inserted between the front and rear flanges 113 and 112, and then, is attached to the magnet holder 110 using an adhesive 114. For convenience of explanation, the following description is specifically limited to attachment of the magnet 120 to the magnet holder 110 using the adhesive 114.

The linear compressor further includes the outer core cover 130 coupled to the side of the outer core 91, and a spring support 136 configured to support a first spring 132 disposed between the support 136 and the back cover 72 and a second spring 134 disposed between the support 136 and the outer core cover 130.

The first and second springs 132 and 134 serve to provide an elastic force to allow the piston 80 to vibrate during reciprocating movement thereof. For this, the first and second springs 132 and 134 temporarily store energy generated in the linear motor 90 to thereby transmit the energy to the piston 80.

The spring support 136 is fastened to the flange 83 of the piston 80 by means of fastening means, such as bolts.

Now, the operation of the linear compressor according to the present invention configured as stated above will be explained.

First, if a voltage is applied to the coil 93, a magnetic field is generated around the coil 93 to interact with the magnet 120, thereby allowing the magnet 120 to linearly reciprocate. The linear reciprocating movement of the magnet 120 is transmitted to the piston 80 via the magnet holder 110 and the inner core 95, allowing the piston 80 to linearly reciprocate inside the cylinder 62.

That is, when the magnet 120 is retracted, i.e. is moved rearward, the rear flange 112 of the magnet holder 110 is pushed rearward by the magnet 120 to thereby push the rear holding protrusion 101 of the first inner core 96 rearward. Thereby, the first inner core 96 is retracted along with the second inner core 97, thereby pushing the flange 83 of the piston 80 rearward. As a result, the piston 80 is moved rearward.

Upon the rearward movement of the piston 80, the suction valve 82 opens the suction channel 81 by a pressure difference between the compression chamber C and the suction channel 81. In this way, fluid inside the suction channel 81 is introduced into the compression chamber C.

On the other hand, when the magnet 120 is advanced, i.e. is moved forward, the front flange 113 of the magnet holder 110 is pushed forward by the magnet 120 to thereby push the front holding protrusion 102 of the second inner core 97 forward. Thereby, the second inner core 97 is advanced along with the first inner core 96, thereby pulling the flange 83 of the piston 80 forward. As a result, the piston 80 is moved forward.

Upon the forward movement of the piston 80, the suction valve 82 closes the suction channel 81 under the influence of the fluid introduced into the compression chamber C and an elastic force thereof. The introduced fluid inside the compression chamber C is compressed by the piston 80. In this case, the fluid inside the hermetic shell 50 is introduced into the suction channel 81 by a negative pressure produced in the suction channel 81 after being passed through the suction pipe 71 of the back cover 72 and the muffler 84 in this sequence.

Meanwhile, when the fluid is compressed by the piston 80 beyond a predetermined pressure, the fluid acts to push the discharge valve 66 forward to thereby be introduced into the inner discharge cover 68. Thereby, the fluid is discharged to the outside of the hermetic shell 50 by passing through the fluid discharge hole 68a, the fluid channel defined between the inner discharge cover 68 and the outer discharge cover 69, the fluid discharge pipe 70, and the loop pipe 54 in this sequence.

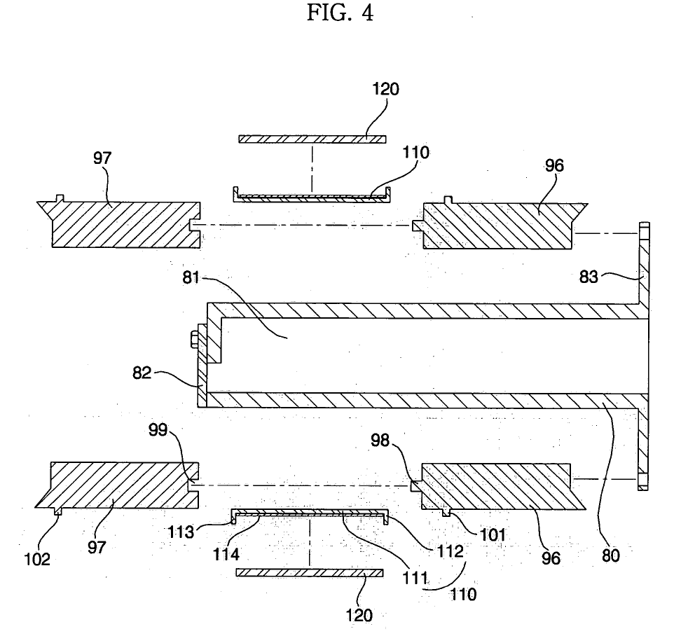

FIG. 4 is an exploded sectional view of the mover shown in FIG. 2.

As shown in FIG. 4, the first inner core 96 is inserted into the cylindrical portion 111 of the magnet holder 110 from a rear side of the cylindrical portion 111, and the second inner core 97 is inserted into the cylindrical portion 111 of the magnet holder 110 from a front side of the cylindrical portion 111. Then, the protrusion 98 of the first inner core 96 is inserted into the recess 99 of the second inner core 97 so that the first and second inner cores 96 and 97 are coupled to each other.

Upon coupling of the first and second inner cores 96 and 97, the rear flange 112 of the magnet holder 110 is caught by the rear holding protrusion 101 of the first inner core 96, and the front flange 113 of the magnet holder 110 is caught by the front holding protrusion 102 of the second inner core 97. In this way, the magnet holder 110 is caught at front and rear ends thereof by the front and rear holding protrusions 102 and 102, thereby being coupled to the outer circumference of the inner core 95.

In succession, after the adhesive 114 is applied to the magnet 120 or magnet holder 110, the magnet 120 is inserted between the front and rear flanges 113 and 112 and is attached to the magnet holder 110.

Finally, the inner core 95, more specifically, the first inner core 96 is fastened to the flange 83 of the piston 80 by means of bolts, or is attached thereto using an adhesive.

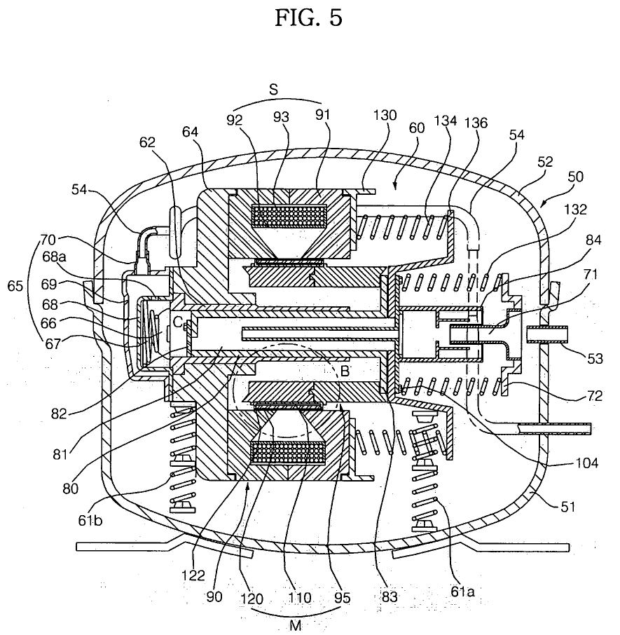

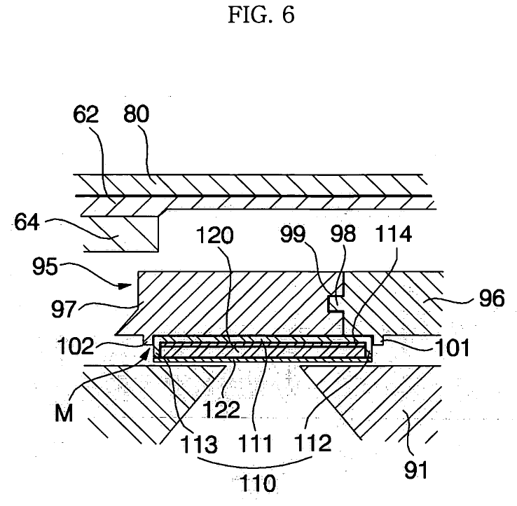

FIG. 5 is a sectional view illustrating the interior configuration of a linear compressor according to a second embodiment of the present invention. FIG. 6 is an enlarged sectional view of the circle B shown in FIG. 5.

As shown in FIGS. 5 and 6, according to the linear compressor of the present embodiment, a carbon winding 122 is wound on the magnet 120 mounted in the magnet holder 110. The other configuration and operation of the present embodiment, except for the carbon winding 122, is identical to the first embodiment. Thus, the same reference numerals will be used in the present embodiment to refer to the same or like parts, and a detailed description will be omitted.

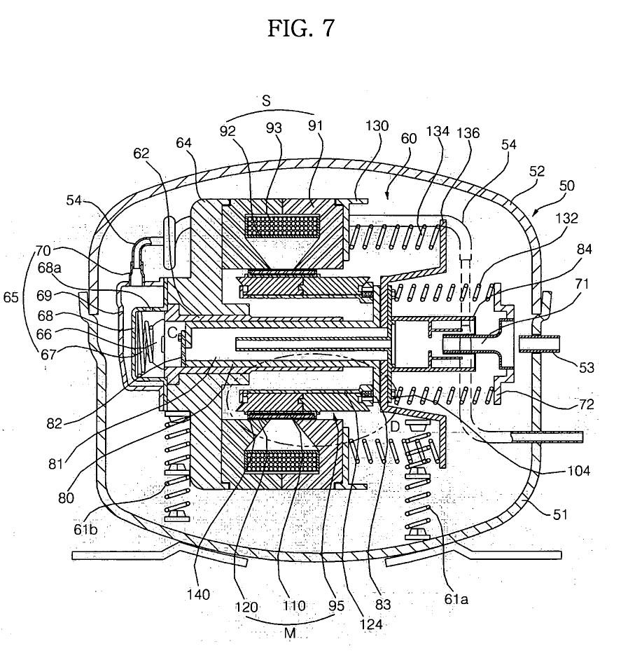

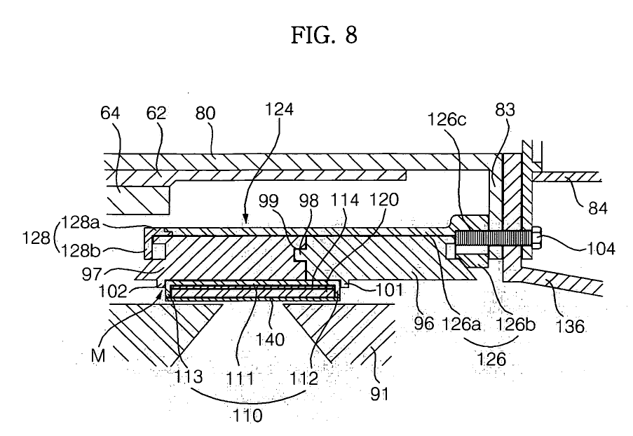

FIG. 7 is a sectional view illustrating the interior configuration of a linear compressor according to a third embodiment of the present invention. FIG. 8 is an enlarged sectional view of the circle D shown in FIG. 7.

As shown in FIGS. 7 and 8, the linear compressor according to the present embodiment includes an inner core holder 124 mounted to the piston 80 to support the inner core 95 mounted thereon. Differently from the first embodiment of the present invention wherein the inner core 95 is directly affixed to the piston 80, the inner core 95 of the present embodiment is connected to the piston 80 via the inner core holder 124.

The other configuration and operation of the present embodiment, except for the inner core holder 124, is identical to the first or second embodiment. Thus, the same reference numerals will be used in the present embodiment to refer to the same or like parts, and a detailed description will be omitted.

The inner core holder 124 is comprised of a first inner core holder 126, and a second inner core holder 128. The first inner core holder 126 is inserted into the inner core 95 until a rear end of the inner core 95 is caught thereby. The first inner core holder 126 is fastened to the flange 83 of the piston 80 by means of bolts. The second inner core holder 128 is coupled to the first inner core holder 126 so that a front end of the inner core 95 is caught by the second inner core holder 128.

The first inner core holder 126 has a cylindrical portion 126a configured to be inserted into the inner core 95, and a protruded rear holding portion 126b radially and outwardly protruded from a rear end of the cylindrical portion 126a to allow the rear end of the inner core 95 to be caught.

At a rear end of the first inner core holder 126 are formed fastening holes 126c so that the first inner core holder 126 is fastened to the flange 83 of the piston 80 by means of bolts 104.

The second inner core holder 128 has a cylindrical portion 128a configured to be inserted into the inner core 95 to be coupled with the cylindrical portion 126a of the first inner core holder 126, and a bent front holding portion 128b radially and outwardly bent from the cylindrical portion 128a to allow the front end of the inner core 95 to be caught.

That is, the cylindrical portion 126a of the first inner core holder 126 is coupled with the cylindrical portion 128a of the second inner core holder 128 inside the inner core 95. The coupling regions of the first and second inner core holders 126 and 128 are supported by an inner circumference of the inner core 95. With this configuration, there is no risk of deformation of the coupling regions due to vibration, etc.

In the case of the linear compressor according to the present embodiment, the inner core 95 is mounted to be caught at the front and rear ends thereof by the inner core holder 124. As a result, the linear compressor according to the present embodiment does not require direct coupling of the first and second inner cores 96 and 97 as in the first embodiment of the present invention.

That is, even if the protrusion 98 of the first inner core 96 is not press fitted into the recess 99 of the second inner core 97, the inner core 95 is able to be mounted to the inner core holder 124.

Now, a assembling procedure of the mover M of the linear motor 90 according to the present embodiment will be explained.

First, after assembling the inner core 95, magnet holder 110, and magnet 120 with one another, the cylindrical portion 126a of the first inner core holder 126 is inserted into the inner core 95 from the rear side of the inner core 95 until the rear end of the inner core 95 is caught by the protruded rear holding portion 126b of the first inner core holder 126.

Next, if the cylindrical portion 128a of the second inner core holder 128 is inserted into the inner core 95 from the front side of the inner core 95, the cylindrical portion 126a of the first inner core holder 126 is coupled with the cylindrical portion 128a of the second inner core holder 128, and the front end of the inner core 95 is caught by the bent front holding portion 128b of the second inner core holder 128.

Finally, the rear end of the first inner core holder 126 is fastened to the flange 83 of the piston 80 by means of the bolts 104.

Admittedly, the present invention is not limited to the above described embodiment, and is adaptable so that the inner core holder 124 is formed as a single member having the cylindrical portion 126a and the protruded rear holding portion 126b. In this case, the front end of the cylindrical portion 126a is bent to form the front bent holding portion 128a.

The linear compressor according to the present invention has the following advantages.

Firstly, according to the linear compressor of the present invention, an inner core is mounted to linearly reciprocate simultaneously with a piston, and a magnet holder, having a magnet mounted therein, is mounted on the inner core. This configuration is effective to simplify the structure of the compressor, resulting in a reduced number of parts and low manufacturing costs.

Secondly, according to the present invention, the inner core is divided into a first inner core having a rear holding protrusion, and a second inner core coupled to a front side of the first inner core and having a front holding protrusion. With this configuration, the magnet holder can be stably mounted on the inner core as front and rear ends thereof are caught by the front and rear holding protrusions of the first and second inner cores. This eliminates the need of separate adhesive for attaching the magnet holder to the inner core, and can prevent deformation of coupling regions of the inner core and the magnet holder, enabling easy tolerance control of the magnet.

Thirdly, as a result of forming a protrusion at one of the first and second inner cores and a recess at the other one of the first and second inner cores, the first and second inner cores can be easily coupled to each other.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present disclosure relates to subject matter contained in Korean Application No. 10-2004-0088258, filed on Nov. 2, 2004, the contents of which are herein expressly incorporated by reference in its entirety.

What is claimed is:

1. A linear compressor comprising: a cylinder; a piston disposed to linearly reciprocate into the cylinder; and a linear motor provided to linearly reciprocate the piston,
wherein the linear motor includes:
an outer core;
a bobbin mounted in the outer core;
a coil wound on the bobbin;
an inner core spaced apart from the outer core to define a gap therebetween, the inner core being mounted to linearly reciprocate simultaneously with the piston;
a magnet holder mounted on the inner core; and
a magnet mounted in the magnet holder.

2. The compressor as set forth in claim 1, wherein the inner core includes a first inner core, and a second inner core coupled to a front side of the first inner core.

3. The compressor as set forth in claim 2, wherein one of the first and second inner cores is provided with a protrusion, and the other one of the first and second inner cores is provided with a recess for the insertion of the protrusion.

4. The compressor as set forth in claim 2, wherein:
the first inner core is formed with a rear holding protrusion so that a rear end of the magnet holder is caught by the rear holding protrusion; and
the second inner core is formed with a front holding protrusion so that a front end of the magnet holder is caught by the front holding protrusion,
whereby the magnet holder is mounted on the inner core as it is caught by the front and rear holding protrusions.

5. The compressor as set forth in claim 1, wherein the magnet holder is made of poly-ether-ether-ketone (PEEK) or polyoxymethylene (POM).

6. The compressor as set forth in claim 1, wherein the magnet holder has:
a cylindrical portion configured to come into close contact with an outer circumference of the inner core; and
front and rear flanges radially protruded from front and rear ends of the cylindrical portion.

7. The compressor as set forth in claim 1, wherein the magnet is attached to the magnet holder by means of an adhesive.

8. The compressor as set forth in claim 1, wherein a carbon winding is wound on an outer circumference of the magnet mounted in the magnet holder.

9. A linear compressor comprising: a cylinder; a piston disposed to linearly reciprocate into the cylinder; and a linear motor provided to linearly reciprocate the piston,
wherein the linear motor includes:
an outer core;
a bobbin mounted in the outer core;
a coil wound on the bobbin;
an inner core spaced apart from the outer core to define a gap therebetween;
an inner core holder mounted to the piston, the inner core being mounted on the inner core holder;
a magnet holder mounted on the inner core; and
a magnet mounted in the magnet holder.

10. The compressor as set forth in claim 9, wherein the inner core includes a first inner core, and a second inner core coupled to a front side of the first inner core.

11. The compressor as set forth in claim 10, wherein one of the first and second inner cores is provided with a protrusion, and the other one of the first and second inner cores is provided with a recess for the insertion of the protrusion.

12. The compressor as set forth in claim 10, wherein:
the first inner core is formed with a rear holding protrusion so that a rear end of the magnet holder is caught by the rear holding protrusion; and
the second inner core is formed with a front holding protrusion so that a front end of the magnet holder is caught by the front holding protrusion,
whereby the magnet holder is mounted on the inner core as it is caught by the front and rear holding protrusions.

13. The compressor as set forth in claim 9, wherein the magnet holder is made of poly-ether-ether-ketone (PEEK) or polyoxymethylene (POM).

14. The compressor as set forth in claim 9, wherein the magnet holder has:
a cylindrical portion configured to come into close contact with an outer circumference of the inner core; and
front and rear flanges radially protruded from front and rear ends of the cylindrical portion.

15. The compressor as set forth in claim 9, wherein the magnet is attached to the magnet holder by means of an adhesive.

16. The compressor as set forth in claim 9, wherein a carbon winding is wound on an outer circumference of the magnet mounted in the magnet holder.

17. The compressor as set forth in claim 9, wherein the inner core holder includes:
a first inner core holder inserted into the inner core so that a rear end of the inner core is caught by the first inner core holder, the first inner core holder being fastened to the piston; and
a second inner core holder inserted into the inner core so that a front end of the inner core is caught by the second inner core holder, the second inner core holder being coupled with the first inner core holder inside the inner core.

18. A linear compressor comprising:
a cylinder block provided with a cylinder;
a back cover provided with a suction pipe;
a piston disposed to linearly reciprocate into the cylinder and internally defining a fluid suction channel;
a suction valve to open or close the fluid suction channel;
a discharge valve assembly mounted to define a compression chamber between the piston and the discharge valve assembly, if fluid inside the compression chamber is compressed beyond a predetermined pressure, the discharge valve assembly serving to discharge the compressed fluid into a loop pipe;
a linear motor including an outer core coupled to the cylinder block, a bobbin mounted in the outer core, a coil wound on the bobbin, an inner core spaced apart from the outer core to define a gap therebetween and mounted to linearly reciprocate simultaneously with the piston, a magnet holder mounted on the inner core, and a magnet mounted in the magnet holder;
an outer core cover provided at a side of the outer core; and
a spring support configured to support a first spring disposed between the support and the back cover and a second spring disposed between the support and the outer core cover.

19. The compressor as set forth in claim 18, wherein the inner core includes:
a first inner core formed with a protrusion and configured to be fastened to the piston; and
a second inner core formed with a recess for the insertion of the protrusion,
whereby the first and second inner cores are coupled to each other as the protrusion is inserted into the recess.

20. The compressor as set forth in claim 18, wherein the linear motor further includes an inner core holder mounted to the piston, the inner core being mounted on the inner core holder.
